(19) United States
(12) Patent Application Publication
(10) Pub. No.: US 2004/0253889 A1
(43) Pub. Date: Dec. 16, 2004

(54) Adhesive tape comprising a polished support surface

(76) Inventor: Stefan Mundt, Dusseldorf (DE)

Correspondence Address: WILLIAM COLLARD, COLLARD & ROE, P.C., 1077 NORTHERN BOULEVARD, ROSLYN, NY, 11576, US

(21) Appl. No.: 10/492,609

(22) PCT Filed: Sep. 26, 2002
(86) PCT No.: PCT/EP02/10801

(30) Foreign Application Priority Data
Oct. 16, 2001 (DE) 101 50 453.5
Apr. 10, 2002 (DE) 202 05 486.1

(51) Int. Cl. B32B 27/12; B32B 27/04; B32B 5/02

(52) U.S. Cl. 442/149; 428/343; 442/301

(57) ABSTRACT

The invention relates to an adhesive tape comprising a tape-type support (1) and an adhesive coating (2) that is applied to one and/or both sides of said support (1). According to the invention, the support (1) is provided at least in sections of one and/or both sides with a polished surface (3). The invention thus provides a uniform grade, cost-effective adhesive tape with a high degree of media resistance, which is particularly suitable for use in the automotive sector.

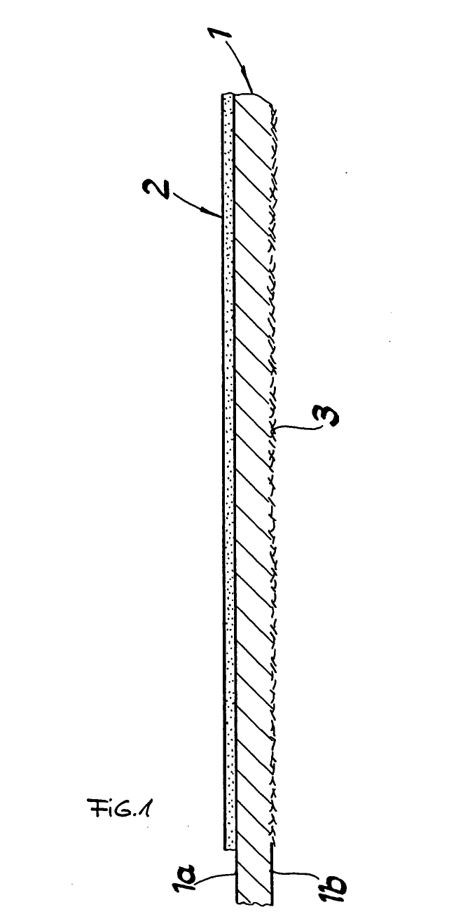

The invention relates to an adhesive tape comprising a polished support surface, and an adhesive coating that is applied to one and/or both sides of the support.

Such adhesive tapes are known from practice, in many different configurations, and are furthermore described in the literature (see, only as an example, EP 0 942 057 A1 with additional references).

The invention is based on the technical problem of further developing an adhesive tape having the configuration described initially, in such a manner that recycling is simplified, at reduced production costs, that simple adhesive coating is possible and, in particular, that the demands on the automotive sector (temperature resistance, resistance to oil, gasoline, and diesel fuel, etc.) are taken into account.

To solve this technical problem, an adhesive tape of the type indicated is characterized in that the support is provided, at least in sections, on one and/or both sides, with a polished surface. Preferably, this surface of the support is chintzed (in each instance).

A quasi-sealed and thereby dirt-repelling surface is achieved by means of the polished finish of the surface of the support, i.e. the high-gloss or chintz effect achieved at this location. In this connection, a continuously chintzed surface on one side of the tape-shaped support is used, in most instances, specifically on the side facing away from the adhesive layer. Fundamentally, of course, the invention also includes configurations such that the surface is polished merely in sections or regions.

In any case, the high-gloss or chintz effect achieved according to the invention opens up a large number of advantages, for example the sealing ability of the tape-shaped support with regard to various media, such as oil, diesel fuel, gasoline, etc., is significantly increased as compared with supports not provided with a polished surface. This explains its dirt-repelling nature. In fact, the sealing ability of the support takes on dimensions that were previously known only for coated or varnished supports. A measure for the sealing ability of the support is the air permeability, which can be reduced to as little as 5% of the original value, as a result of the chintz effect, depending on the type of support.

In total, a support surface that appears to be sealed, in regions or continuously, is made available, something that was previously observed only for coated or varnished supports. As compared with such support tapes, the adhesive tape according to the invention is convincing because of its uniform-grade, cost-effective structure, which is particularly advantageous in connection with recycling.

Because of the very smooth and highly compact one-sided and/or two-sided surface of the support, a coating can be achieved in much simpler manner than previously, because the adhesive, which is generally applied with a doctor roller, hardly penetrates into the support material, so that in comparison with what was previously known, a lower adhesive application weight is achieved, with comparable adhesion values. As a result of this, the additional advantage is achieved that adhesives or melt glues having a low viscosity can easily be applied to the chintzed support according to the invention, because this adhesive, as described, does not penetrate into the support, or hardly penetrates it at all, i.e. does not permeate it. Such low-viscosity melt glues can fundamentally be transported and processed more simply than is the case for high-viscosity adhesives. As a result, the production speeds increase, and scrap is reduced, so that all in all, productivity is clearly increased and therefore costs are decreased.

Since at least the surface facing away from the adhesive coating is chintzed, not only is the adhesive tape according to the invention protected against media influences, but in particular, the adhesive coating virtually located below the polished surface is also protected. This has the result that the adhesion properties of the adhesive tape described remain almost completely unimpressed by external influences and, in particular, have a long lifetime stability.

Finally, it must be taken into consideration that the process of chintzing gives the support a particularly flexible character, so that the adaptation capacity of the adhesive tape made from it, i.e. its flexibility, is increased, and an improved fixing in place of cables to be bundled against one another, for example, is made possible. Cable sets produced in this manner are therefore characterized by particular flexibility and a smooth surface.

In order to be able to achieve the chintz effect described, the support, i.e. the support material is passed through between two rollers, i.e. calander rollers. This can be done in a slightly damp state. The calander described is composed of a hard steel roller, usually a heated roller, and a counter-roller that is soft in comparison. The heated steel roller runs at a higher circumference speed as compared with the soft counter-roller, which is actually responsible for the transport of the tape-shaped support through the calander. In this way, speeds of rotation of at most several 100 rpm are observed at this location, for the soft counter-roller, while the hard and heated steel roller (approximately 100° C. to 200° C., preferably approximately 150° C.) is run at 1000 to 1500 rpm, specifically depending on the circumference or diameter. A contact pressure force of approximately 300 N now ensures that the heated steel roller works with a friction effect relative to the soft counter-roller, which is clearly running at a slower speed, specifically in the sense of “frictionation.” The fibers of the support are completely polished smooth on the surface that faces the steel roller, and the support is given an intense gloss there.

It is understood that the process of chintzing or polishing of the surface, as described, can be used for a large number of different support types. It is possible here, that the support is structured as a woven textile, non-woven textile, or comparable flat structure formed of fibers, particularly synthetic fibers. In this connection, it has proven to be advantageous if the support is provided with a material thickness of 0.06 mm to 0.50 mm, preferably 0.06 mm to 0.30 mm, particularly 0.15 mm to 0.20 mm.

The suitability of the adhesive tape for bundling cables in automobiles particularly exists in the case when the support possesses a tear strength of approximately 100 N/cm to 300 N/cm. In this connection, its elongation to tear generally lies in the range between approximately 10% and approximately 40%.

In order to facilitate the initial tear ability at the edge and thereby the processing of the adhesive tape described, a woven textile composed of different warp and weft threads having different values for elongation to tear and tear strength can be used at this point. Thus it has proven to be practical if the warp threads are structured as a mixed woven textile of polyester/cotton, for example, in which an initial tear can easily be made by hand. In contrast, a more tear-resistant material, e.g. polyester, will be used for the weft threads, in order to increase the overall initial tear ability at the edge, in the direction of the warp threads.

Although the adhesive tape as such already demonstrates an excellent fire behavior, because of the smooth and relatively small surface, even without additives, the invention nevertheless proposes the supplemental introduction of a flame retardant. This can be ammonium polyphosphate. The use of a modified polyester material that virtually has a flame retardant bound into the molecular structure is covered by the invention. This flame retardant built into the molecular structure is released at appropriate temperatures, and produces the desired flame-retardant effect.

Of course it is also possible and imaginable to reduce the aging capacity, i.e. strength losses by means of direct sunlight, which can be done by means of adding commercially available UV stabilizers.

In addition, the support can also be provided with a finishing and/or varnish layer on one and/or both sides, whereby a varnish based on acrylate is preferably used as the varnish. This makes it possible to present a laminate, in order to additionally improve other properties such as roll-off behavior and labeling ability. Measures for surface embossing aim in a comparable direction.

The support can have different tear strength values in the lengthwise direction and the crosswise direction. This can be achieved, in the case of a woven textile tape support, in that the warp threads that run in the lengthwise direction are thinner (in other words have a lower tear strength) than the related weft threads. In this manner, an initial tear in the adhesive tape can easily be made in the crosswise direction. Of course it is also possible to structure the warp threads to be heavier than the related weft threads, in order to make an initial tear in the lengthwise direction easier, if this is desired.

The use of the adhesive tape as described, as a wrapping tape for bundling or mantling cables in automobiles, is another object of the invention. In this connection, the adhesive tape in question is particularly predestined for this case of use, since it is suitable for use in the entire automobile, because of its low production costs. This means that no distinction has to be made any longer between adhesive tapes for the vehicle interior and the engine space. Instead, one and the same (cost-effective) adhesive tape according to the invention can be used throughout.

In order to allow a practical differentiation of the cable groups provided with the adhesive tapes, the support can easily be dyed. This is usually achieved by the invention in that inorganic pigments are added to the extrudate, from which filaments and then woven filament textiles are generally produced. Of course it is also possible and imaginable to provide not only such “in situ” dyeing, but also subsequent coloring of the support. The inorganic pigment dyeing as described, by means of adding colors during extrusion, is characterized by particular color stability and aging resistance.

In all, an adhesive tape is made available, which makes do with clearly less material per surface unit, at the same density, i.e. air permeability, in comparison with previously known configurations. This is achieved without the addition of coatings, varnishes, etc., thereby making it possible to recycle the adhesive tape directly and without great effort. The process of surface polishing of the support, on one and/or both sides, which takes place at least in sections, is responsible for this. This is generally achieved by means of chintzing, in other words a calandering process in which the individual calander rollers are intentionally operated at different speeds of rotation, thereby producing friction at the surface.

As a result of the surface seal and the relatively small surface of the support according to the invention, the flame behavior of the support tape per se is excellent, because in the final analysis, a flame only works its way into the support from the surface, and here has the result that the support melts and drips off. It can therefore not be expected that the adhesive tape as such will start to burn. Of course the flame-retardant behavior can be further improved by adding flame retardants, as described.

Usually, a woven textile, which is composed of a polymer, such as polyester (or also polypropylene), is used as the support. In this connection, a woven filament textile, in other words a woven textile that is woven from individual filaments, has proven itself. When using a polyester filament woven textile, a particularly high level of temperature stability is achieved.

Fundamentally, however, non-woven textiles or comparable flat structures can also be used as supports, as long as their surface can be polished in the manner described, at least in certain regions. This is where the significant advantages can be seen.

In the following, the invention will be explained in greater detail using a drawing that merely shows an exemplary embodiment; the sole FIGURE shows an adhesive tape in accordance with the object of the application, in a schematic cross-sectional view.

The representation of the drawing shows an adhesive tape that is composed, in terms of its fundamental structure, of a tape-shaped support 1 and an adhesive coating 2 that is applied on one side. In the exemplary embodiment, the adhesive coating 2 covers one side 1a of the support 1 although, of course, additionally or alternatively, the other side 1b can also have a corresponding adhesive coating 2.

Within the scope of the invention, the support 1 is continuously provided with a polished surface 3 on one side (not only in certain regions, which is also possible), specifically the side 1b of the support 1.

Of course, alternatively or additionally, the other side 1a of the support 1 can also be provided with the polished surface 3 in question. This polished surface 3 is produced in that the tape-shaped support 1 passes through a gap of a calander, between a heated, hard steel roller and a soft counter-roller. In this connection, the side 1b of the support 1 rests against the heated steel roller (not shown), which runs at a (clearly) higher circumference speed than the elastic counter-roller that rests against the opposite surface side 1a of the support 1, and therefore causes friction.

Because of this friction, individual fibers, of which the support 1 is composed, are completely polished smooth at the surface side 1b first mentioned, and the support 1 is given an intense gloss there. The polishing track connected with this is indicated by lines in the FIGURE, instead of the original surface side 1b of the support 1, and is supposed to illustrate the chintz effect that occurs there, i.e. the polished surface 3, as it is fundamentally described in DE 43 41 532 C1, to which explicit reference is made in this connection.

Within the scope of the representation, the support 1 is a woven textile made of polyester, i.e. polyester filaments, for example, whereby approximately 30 to 50 threads/cm, preferably 40 to 45 threads/cm, are used in the warp direction. The weft direction, in contrast, has 20 to 50 threads/cm, preferably 20 to 30 threads/cm, but this is not compulsory and restrictive, overall. Both in the warp direction and in the weft direction of the support 1, i.e. of the woven textile used there, a gauge of 30 to 180 denier, preferably 150 denier, is observed. When using synthetic fibers, particularly high mechanical stability is achieved.

The warp threads in the longitudinal direction of the support 1 are thinner, i.e. have a smaller cross-section than the related weft threads. As a result, the support 1 has different tear strength values in the lengthwise direction and the crosswise direction. In this manner, an initial tear in the support 1 and the adhesive tape made from it can easily be made (by hand).

In terms of its thickness, the support 1 is in a range between 0.06 mm and 0.50 mm, and has a sealing capacity, i.e. air permeability of less than 30 L/m²s. The tear strength of the support 1 (in the crosswise direction) can be stated at 100 N/cm to 300 N/cm, and the elongation to tear is approximately 10% to 40%.

By means of adding a flame retardant, e.g. ammonium polyphosphate, it is possible to make the support 1, overall, and thereby the adhesive tape, as a whole, flame-retardant. —The possibility of providing the support 1 with an additional finishing or varnish coating on one side and/or both sides, which coating is preferably produced on the basis of acrylate, is not shown.

Within the framework of the exemplary embodiment, the adhesive coating 2 has been produced in such a manner that a melt adhesive has been applied to the side, i.e. surface side 1a of the support 1, in other words the adhesive coating 2 is located on the side of the support 1 that faces away from the polished surf ace 3. To present the surface coating, a melt adhesive is preferably used, which is produced on the basis of acrylate or rubber, whereby this can particularly be an acrylate adhesive that can be cross-linked by UV light.

The adhesive tape as described is usually used for mantling and bundling cables, pipes, or similar objects having a lengthwise expanse, for example. Use of the adhesive tape as a wrapping tape for mantling cable bundles in automobiles, preferably in the engine space of automobiles, is particularly preferred.

1. Adhesive tape comprising a tape-type support (1), and an adhesive coating (2) applied to the support (1) on one and/or both sides, characterized in that the support (1) has a polished surface (3) on one and/or both sides, at least in sections.

2. Adhesive tape according to claim 1, wherein the polished surface (3) of the support (1) is chintzed.

3. Adhesive tape according to claim 1, wherein a woven textile, a non-woven textile, or a similar flat structure is used as the support (1).

4. Adhesive tape according to claim 1, wherein the support (1) has a material thickness of 0.06 mm to 0.50 mm.

5. Adhesive tape according to claim 1, wherein the support (1) has a tear strength of approximately 100 N/cm to 300 N/cm.

6. Adhesive tape according to claim 1, wherein the support (1) has an elongation to tear of 10% to 40%.

7. Adhesive tape according to claim 1, wherein the support (1) is made flame-retardant by means of the addition of a flame-retardant, e.g. ammonium polyphosphate, or by means of the addition of a modified (polyester) material.

8. Adhesive tape according to claim 1, wherein the support (1) is provided with a finishing and/or varnish coating on one and/or both sides.

9. Adhesive tape according to claim 1, wherein the support (1) has different tear strength values in the lengthwise direction and the crosswise direction.

10. Adhesive tape according to claim 1, wherein a melt glue, preferably based on acrylate or rubber, is used as the adhesive coating (2).

11. Use of an adhesive tape according to claim 1, as a wrapping tape for mantling cables in automobiles.
